(19) United States
(12) Patent Application Publication
(10) Pub. No.: US 2018/0298798 A1
(43) Pub. Date: Oct. 18, 2018

(54) REAL TIME FLUID LEVEL MONITORING SYSTEM

(71) Applicant: Allan Dikeman, Tremont, IL (US)

(72) Inventor: Allan Dikeman, Tremont, IL (US)

(21) Appl. No.: 15/954,551

(22) Filed: Apr. 16, 2018

Related U.S. Application Data
(60) Provisional application No. 62/485,622, filed on Apr. 14, 2017.

(51) Int. Cl. F01M 11/12; G01F 23/00

(52) U.S. Cl. CPC F01M 11/12; G01F 25/0061; G01F 23/0007; G01F 23/0061

(57) ABSTRACT

The present invention is a real time fluid level monitoring system comprising a time of flight sensor coupled to a data processing unit with a means to output the measured fluid level data. The system may be configured to monitor fluid levels such as engine oil, hydraulic oil, coolant, fuel, and wiper fluids in automobiles and commercials. The time of flight sensor may be installed at the top of the fluid vessel and calibrated for the vessel size. The data processing unit communicates with the time of flight sensor to relay real time data concerning fluid level measurements to the operator of the automobile or commercial vehicle.

### CROSS-REFERENCE TO RELATED APPLICATIONS

The present application claims priority from U.S. Provisional Application Ser. No. 62/485,622, filed Apr. 14, 2017 all of which is herein incorporated by reference in their entireties.

### BACKGROUND OF THE INVENTION

The present invention pertains generally to the field of fluid level management systems used in the automotive, agricultural vehicle, and construction vehicle industries. More particularly, this invention relates to the continuous or static metering and reporting of fluid levels and consumption for a vehicle.

For commercial and construction vehicles, the industry standard is for the operator to check the oil level of the vehicle before the first startup of the day. This slows start up time as well as introducing human error. If an operator forgets to check the oil level or incorrectly checks the dip stick, a dry engine will reach critical damage in as little as six seconds.

In the prior art, oil engine levels have been traditionally determined manually by the use of a dipstick or through a variety of sensors including mechanical sensors, conductive sensors, and ultrasonic sensors. A dipstick can be utilized to check the current oil levels, but can only be used when the vehicle is parked and cannot give real time data while the vehicle is moving. Typical mechanical sensors include magnetic floats switches that are set to trigger a warning at a pre-determined low level of fluid. Conductive sensors typically involve at least two electrodes in the liquid container, and when the liquid level reaches a certain point it will come into contact with both electrodes completing the circuit and triggering a warning. Conductive sensors are limited to fluids that are conductive. Ultrasonic sensors are capable of taking real time distance measurements by bouncing a soundwave off of the fluid, however, in a dynamic system where the fluid is moving, the soundwave cannot properly be bounced back to the sensor and no reading can be taken.

Both mechanical and conductive sensors are generally binary in the sense that the circuit is either completed or disconnected at set fluid levels. Neither sensor set is designed for continuous real time fluid level monitoring, but rather to determine if the fluid level has reached a particular low in the fluid vessel.

The present invention addresses the issue of continuous real time fluid level metering and monitoring with the use of a non-contact time of flight sensor. A time of flight sensor measures the time-of-flight required for a light pulse to leave the sensor and reflect back onto an image sensor or focal plane array of the sensor. The time it takes for the light pulse to return back to the sensor directly correlates with the distance of the object that the light pulse is bouncing off of Light pulses are typically generated by LEDs or lasers.

### SUMMARY OF THE INVENTION

In view of the above, a real time fluid level and monitoring system utilizing a time of flight sensor is disclosed. The advantage of the present invention is that because the time of flight image sensor captures everything the light pulse bounces off of, it can detect the full profile of a fluid level. In the case that the vehicle is moving, and the liquid plane is not parallel to the image sensor, a data processing unit can then average out the profile relative to fluid vessel to give an accurate reading as to the current fluid level. Using the time of flight sensor allows for a vehicle operator or fleet manager to view exact fluid levels and changes over time for any particular fluid such as engine oil, hydraulic oil, coolant, fuel, and wiper fluids.

In one example embodiment of the present invention, the real time fluid level and monitoring system comprises a time of flight sensor coupled to a data processing unit, the data processing unit further coupled to an output display, all components coupled to a power source.

In an additional aspect of the invention, the time of flight sensor is encased in a protective housing configured to mount to a fluid vessel. The time of flight sensor is electrically coupled through a cable or wirelessly coupled through conventional wireless means including but not limited to Bluetooth, Wi-Fi, NFC, or cellular modem to the data processing unit. The data processing unit comprises a microprocessor, memory, and a set of software instructions configured to communicate and relay information between the data processing unit and the time of flight sensor. In some embodiments the data processing unit is coupled to a display and configured to output real time fluid level measurements including but not limited to the remaining fluid volume, a percentage of remaining fluid volume, indicators as to the tank being “full,” “low,” or “empty,” warning indicators.

In some embodiments the data processing unit may be configured to output fluid level indicators through the use of a multicolor LED wherein each color represents a particular fluid level.

In additional embodiments, the data processing unit may be configured to output fluid level indicators and data wirelessly to a display, mobile device or cloud server through industry standard wireless means including but not limited to Bluetooth, Wi-Fi, NFC, or cellular modem.

In yet another embodiment the system may include a GPS positioning module configured to relay positioning data to the data processing unit and be outputted onto the display or sent to a fleet managing cloud server where managers may view collect fluid levels relative to GPS position.

An additional aspect of the invention includes the data processing unit configured with software instructions that upon powering on the system includes the step of averaging out the measurement signal to establish a baseline measurement, activate the sensor to emit a light pulse and monitor fluid range levels, collect fluid level range and output the levels to the display. In some embodiments, the software is configured to instruct the data processing unit to analyze the fluid level for preset fluid level ranges including but not limited to “full,” “add,” or “critically low,” and output the resulting range to the display, LED, cloud server or mobile device. In some embodiments, the software is configured to instruct the data processing unit to output the fluid level volume or remaining percentage of fluid relative to the vessel to the display, LED as a preselected color, cloud server or mobile device.

In some embodiments, the data processing unit may be calibrated for the particular fluid vessel either directly through a user interface on the display controlled by touch or physical buttons. In other embodiments, the data processing unit may be calibrated for the particular fluid vessel through a computer or mobile device via a cable or an industry standard wireless means.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 represents a diagram of an embodiment of the present inventive system.

FIG. 2 represents a block diagram of an embodiment of the present invention.

FIG. 3 is a flow chart diagram representing the display activation of the system.

FIG. 4 is a flow chart diagram representing an embodiment of the system in operation.

FIG. 5 is a flow chart diagram representing a method of fluid container calibration.

FIGS. 6A-B represent diagrams displaying example correlations between oil level, engine speed and volume.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

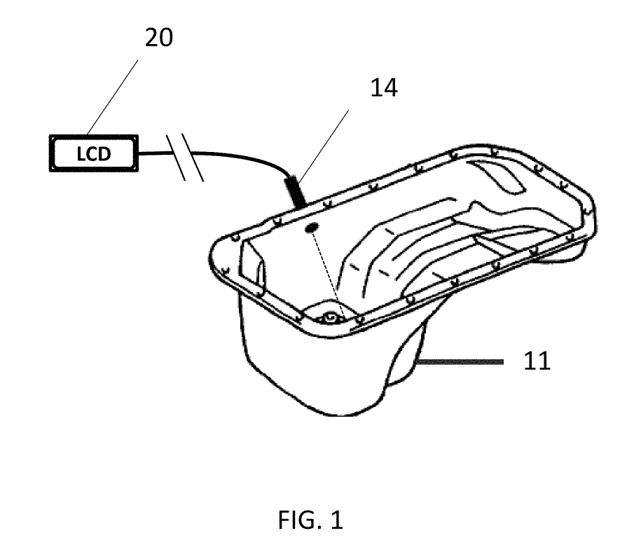

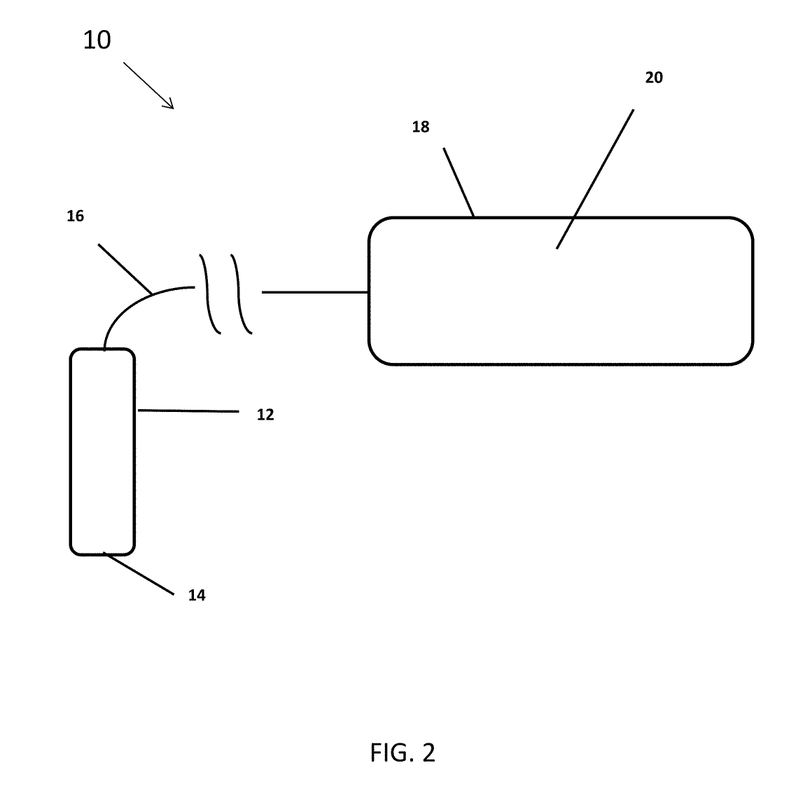

FIG. 1 displays the real time fluid level monitoring system 10, mounted within an oil pan 11 of an automobile. As shown in FIG. 2, the real time fluid level monitoring system 10 comprises a time of flight sensor 12, a sensor housing 14 mounted within a fluid vessel, tank, or sump, wires 16 configured to couple the sensor to a data processing unit 18, and display 20 coupled to the data processing unit 18. In some embodiments a single power supply is coupled to each system component, but in other embodiments, each component unit has its own power supply. The power supply may be for example a portable battery or an adapter used to plug into the vehicle's existing power supply.

When the system 10 is installed, the sensor housing 14 is mounted to the top of the oil pan 11 and configured such that the time of flight sensor 12 is optically coupled to the oil within the pan 11. In one embodiment of the invention, the time of flight sensor 12 is an STMICRO VL53LOX sensor. It is to be understood, however, by one of skill in the art that the STMICRO VL53LOX sensor is an example time of flight sensor 12 used in the system, and that a number of similar or compatible time of flight sensors exist having the same or similar functionality that can be substituted. In this embodiment, the time of light sensor 12 is configured to measure the time it takes for an emitted laser pulse to bounce off the surface of the oil and return to the sensor 12. The time calculation is then used to determine the distance that the light traveled, and the height level of the fluid within the oil pan 11. The sensor housing 14 may be used to protect the time of flight sensor 12 as well as house additional components such as a sensor power supply or means for wireless communication coupled to the time of flight sensor 12 including but not limited to Wi-Fi, Cellular, or Bluetooth.

The time of flight sensor 12 is coupled either through wires or through a wireless means as described above to the data processing unit 18. The data processing unit 18 may comprise a microprocessor/microcontroller, a wireless communication means, memory and a means to communicate with an external display 20. In some embodiments, the data processing unit 18 comprises a Photon chipset including a Broadcom WICED Wi-Fi chip as well as an STM32 ARM Cortex M3 microcontroller, 1 MB flash memory, as well as 128 KB RAM. One of skill in the art would recognize that there are multiple equivalent Wi-Fi chipsets and microcontroller chipsets, and that varying the amount of RAM and flash memory may be used to increase performance or lower costs.

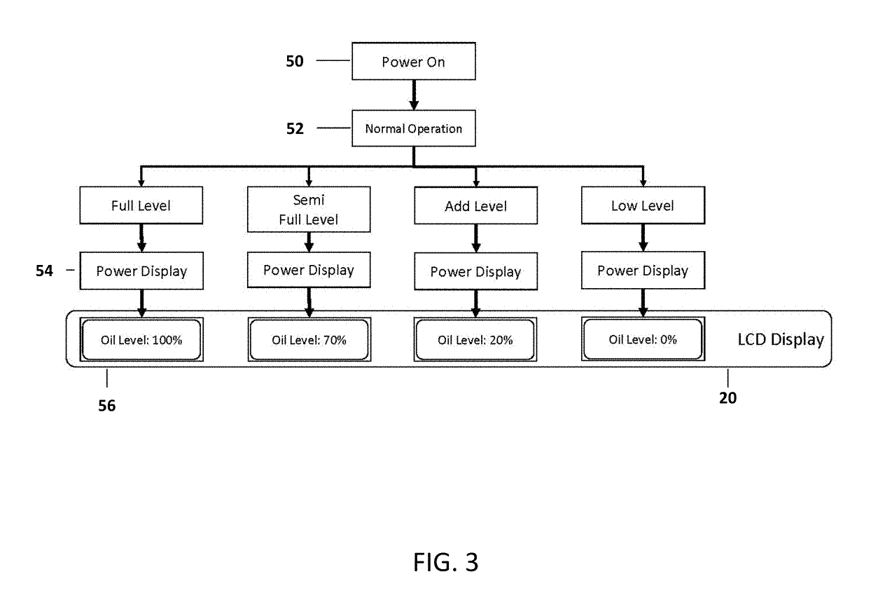

In a high level overview of the system 10 operation, the microprocessor/microcontroller 18 is configured to receive data from time of flight sensor 12 and relay that data to the display 20 or cloud server through a wireless connection means. As shown in the high level overview of FIG. 3, when the real time fluid level monitoring system 10 is powered on 50, the system 10 will typically load a normal operation profile 52, which in turn will load a setup file. The setup file loads a preprogramed calibration profile for the particular fluid vessel that is being measured. For example, it may contain the appropriate dimensions relating to an oil pan for a particular vehicle, or the dimensions of a coolant vessel, fuel tank, or wiper fluid vessel. Different machines require different calibrations due to the variations in sumps and or tanks. If a setup/calibration profile has not been created, the system will run a process to calibrate for the particular application. This process will set the device to read the specific tank the user wants to monitor. Each step represents a known value in correlation to manufacture specifications of Full, Add, Empty. The dimensions of the vessel can be manually inputted through the use of physical buttons or touch interface buttons on the display 20, or the depth of the empty tank can be determined by the sensor 12. After the normal operations profile 52 is complete, the display can be powered on 54, or the level reading can be sent to an external display to indicate the oil level 56 on the display 20 or the external display. In some embodiments the external display 20 may be a mobile software application or a backend cloudserver.

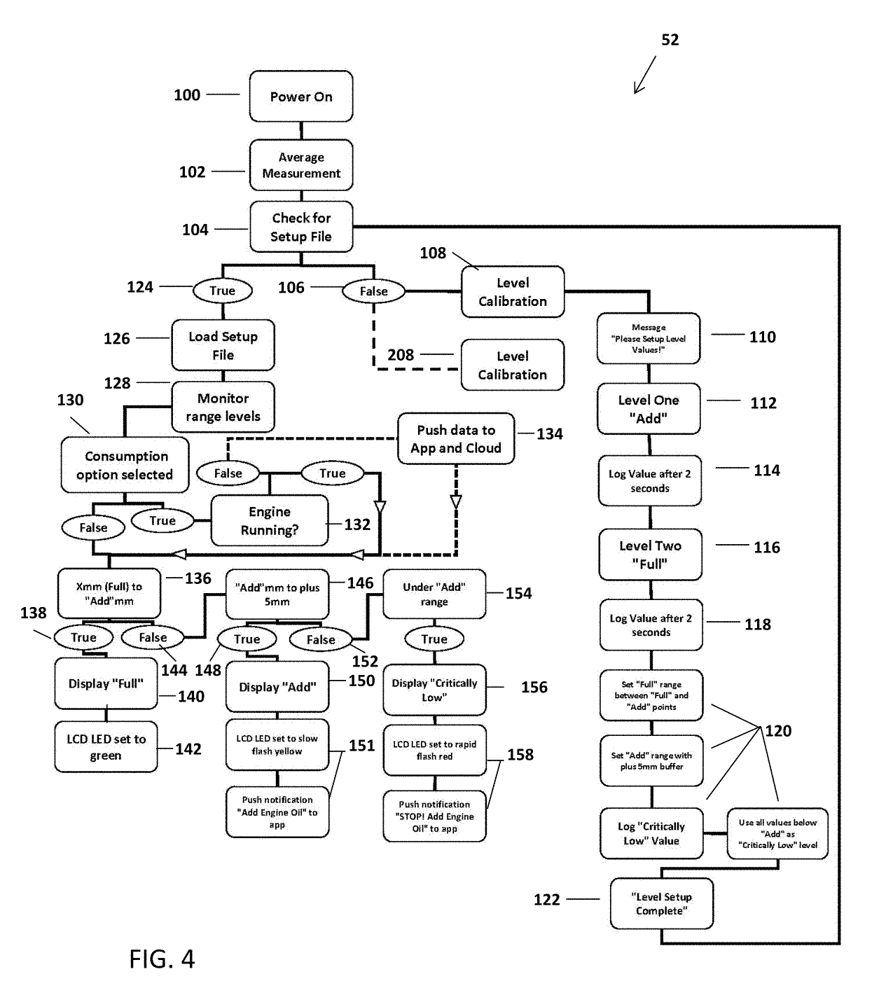

A more complete representation of the normal operation profile 52 can be viewed in the flow chart of FIG. 4. As shown in the normal operation flow chart, the system 10 is activated when powered on 100, the system 10 then initiates an initial average measurement sequence 102 to determine fluid levels. Next, the system 10 initiates a check for setup file routine 104, if the setup file is not available 106 the system 10 initiates a level calibration routine 108, 208. The level calibration routine 108, 208 can be divided into separate subroutines depending on the need of the users. A first embodiment of the level calibration subroutine 108 comprises the steps of setting critical measurement values relating to the oil tank 11. The first step in process involves prompting the user to set tank level values 110 by first setting the “Add” level 112. The Add level is defined as the height of the oil within the tank 11 when the oil volume is at a minimal operational level. In other subroutines with the system 10, the user will be alerted when the oil level reaches the “Add” level, and prompted to add oil. The user sets the Add level, by filling the tank 11 up to the appropriate oil level and initiates a log sequence 114. During the log sequence 114, the system 10 takes the height measurement and retains the Add level value. In some embodiments the system 10 will log the value two or more seconds after the user initiates the log sequence 114 to ensure level stability. After the Add level sequence 112 has been completed, the system 10 initiates a “Full” level sequence 116. The Full level is defined as the oil height within the tank 11 in which the tank 11 would be considered full. In other subroutines with the system 10, the user will see a full indicator when the oil level reaches the “Full” level. The user sets the Full level, by filling the tank 11 up to the appropriate oil level and initiates a log sequence 118. During the log sequence 118, the system 10 takes the height measurement and retains the Full level value. In some embodiments the system 10 will log the value two or more seconds after the user initiates the log sequence 118 to ensure level stability. In some embodiments after the Add and Full levels are set, or after the Add level is set, the system 10 generates a “Critically Low” level through an additional routine 120. The critically low level is determined by a process 120, wherein the system 10 subtracts a predetermined height or buffer range from the Add level. In this process 120 the system 10 may also set a Full range indicating any oil level reading above add and beneath the Full level and a Critically low range for any oil level beneath the Add level. In other subroutines with the system 10, the user will be alerted when the oil level reaches the “Critically Low” level, and is prompted to add oil or that engine damage is imminent. After the Critically Low level subroutine 120 is processed, the setup is complete and a user may be prompted accordingly 122.

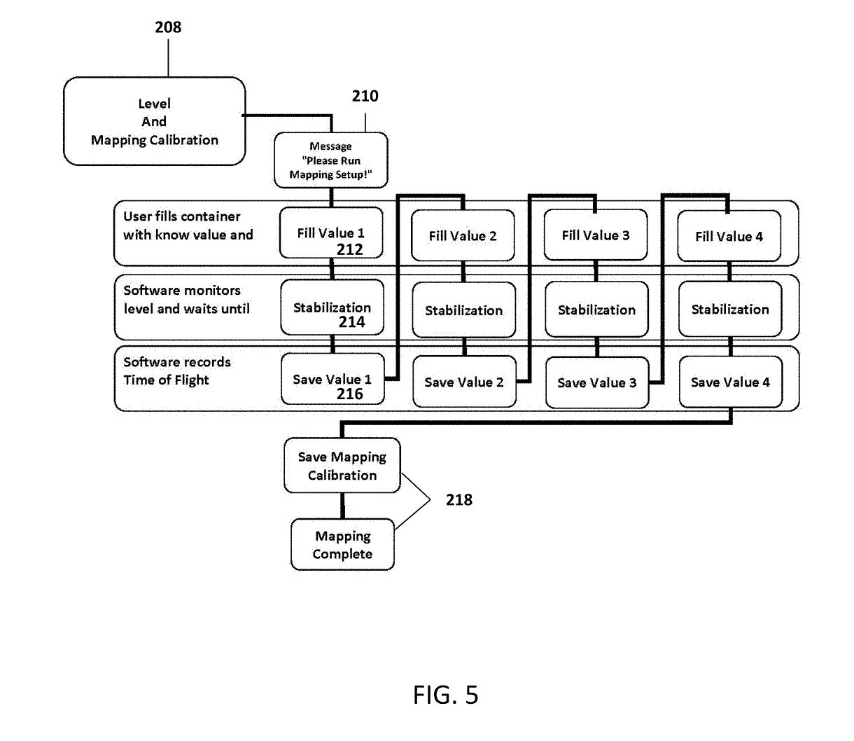

A second embodiment of the level calibration subroutine 208 shown in FIG. 5 is designed to volumetrically map out a fluid tank 11 to create reusable configurations and profiles of new and existing tanks 11. Similar to the level calibration subroutine 108, the user is prompted to run mapping setup 210 and initiate the fill value 1 subroutine 212. In this routine, the user adds a known quantity of fluid, for example, one gallon. The system 10 next monitors and waits until the fluid is stabilized 214 and saves the height data 216 in connection with user inputted volume data. This subroutine is repeated a number of times for sequential volume and height values and a general volume of the tank 11 is then calculated with the system 10 being able to determine based on the volume and height level data where the Critically Low level, Add level, and Full level are. The data is then stored 218 in a new mapped setup file and the subroutine 208 returns to the normal operation routine 52.

Upon completion of the setup file, the system returns to the check setup file subroutine 104, finds the setup file 124 and initiates the load setup file subroutine 126 to begin the monitor range levels subroutine 128 configured to actively measure fluid levels. The monitor range levels subroutine may initiate a Consumption option 130 subroutine. The Consumption option 130 is another function allows the system 10 to generate a consumption report wherein the operator can setup a consumption report that will be logged either on the data processing unit 18 memory, or sent wirelessly to a mobile device or cloud server. Individual data points can be logged or pushed to a mobile device or cloud server. In some embodiments, the data points are measured in quarts and used to calculate the difference between previous selected points. If the Consumption option 130 subroutine is initiated, the system 10 checks if the engine is running 130. If the engine is not running 132, the system 10 records the height data of the oil and may store the data in a consumption database either locally, or pushes the data to an associated software application or back end cloud computer 134. If the engine is running, the system 10 runs additional subroutines to check the average measurement against Full, Add, and Under Add, or Critically low levels, and outputs that data to a display 20 or a software application or backend cloud server.

Upon completion of the optional Consumption option subroutine 130, a level reporting subroutine 136 may be initiated to report real-time oil levels to the display or backend cloud server. In operation, this subroutine 136 may include checking to see if the oil is at the Full level, if so 138, a display Full command 140 is pushed to a display 20 or a software application or backend cloud server or an LED indicator 142, if not 144, the system may run the Add subroutine 146 to see if the oil measures above the Add level. If the oil is at the Add level 148, a display Add command 150 is pushed to a display 20 or a software application or backend cloud server or an LED indicator 151, if not 152, the Under Add or critically low subroutine 154 may be initiated to see if the oil is at a level that is dangerously low. If at the Under Add Level, a display Critically Low command 156 is pushed to a display 20 or a software application or backend cloud server or an LED indicator 158.

It is to be understood by one of skill in the art that the normal operation profile 52 shown in FIG. 3 is meant to be a detailed example outlining multiple potential options available within the system 10. It is also to be understood that other embodiments of the system may have a built-in or preconfigured setup file and not require or use and level calibration 108, 208 processes or that that instead of displaying the Full, Add, or Critically low ranges, the system 10 may also output the exact oil level reading in any standard volumetric measurement units.

In each of these configurations, the sensor 12 can operate up to 400 kHz. In some embodiments, it is found that taking 10 second blocks readings provides the necessary data without providing too much data and using too much memory.

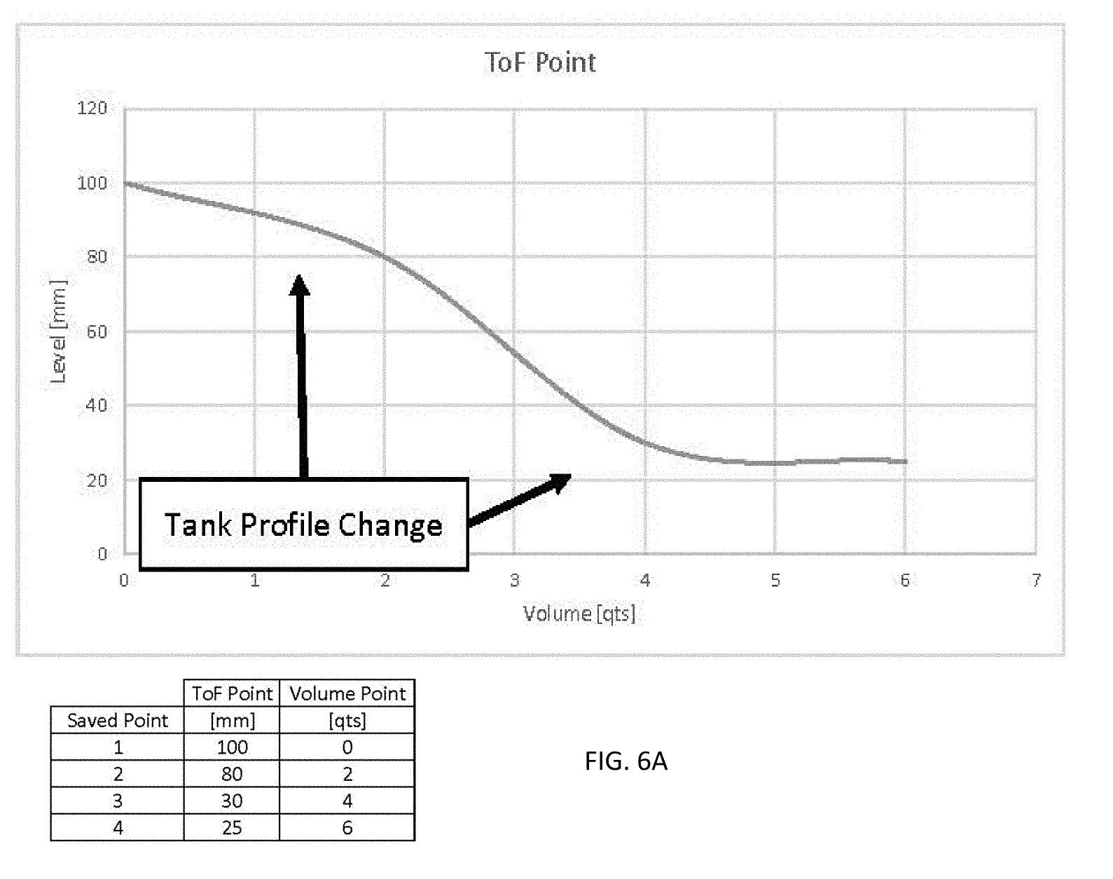

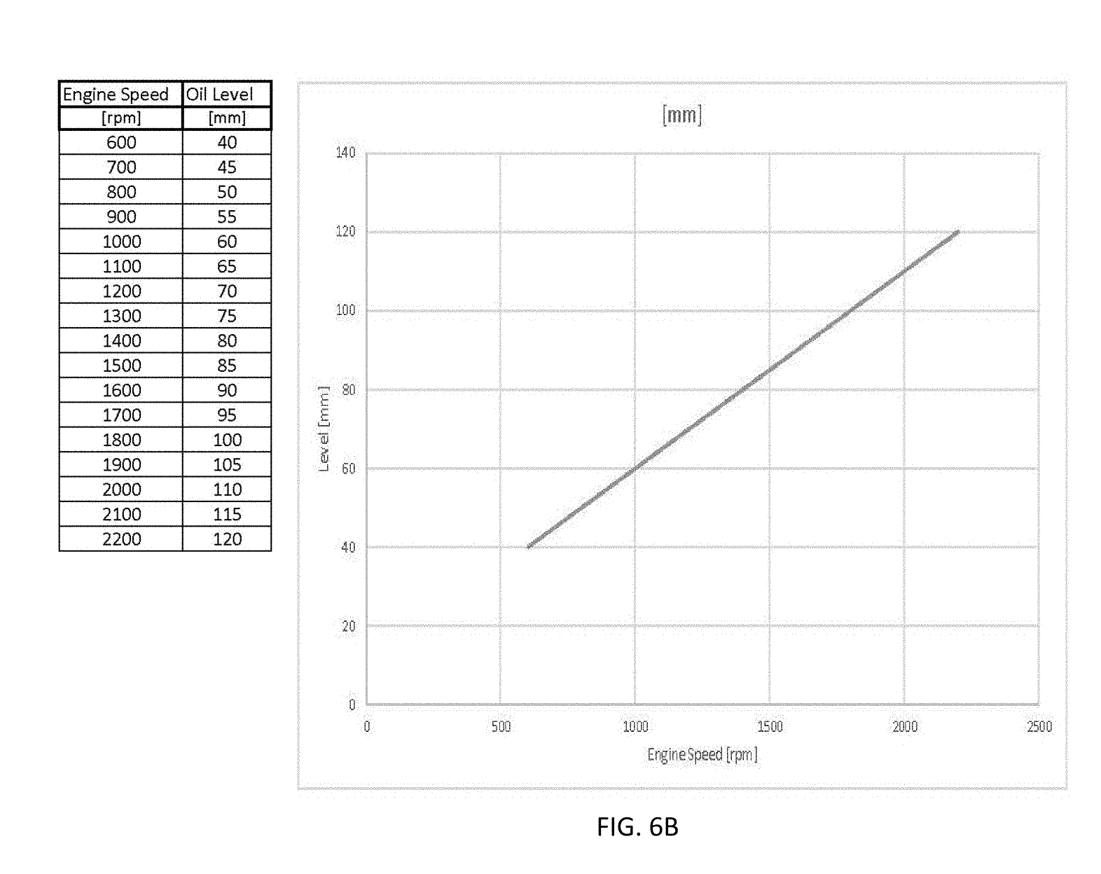

In some embodiments of the system 10, a vibration sensor 22, may be integrated into the sensor housing 14. As shown in FIGS. 6A-B, engine rpm correlates to oil use, when vibration reaches different pre-determined levels that correlate with rpm, the reading will shift to follow the typical oil level per rpm of the engine. In a consumption report, a data point is collected at each system 10 start-up to measure consumption. The first data point collection will be higher than the next typically. The second data point is subtracted from the first to determine historical consumption. A consumption operation/report can be gathered automatically at the power on and power off of the system 10 or at operator selected points while powered on. In order to monitor consumption rate a mapping calibration needs to be performed on the tank the device is measuring. The software will record each step and extrapolate that data to find the volume of the tank. A sample chart is shown below in FIGS. 6A-B.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1. A system for measuring fluid levels comprising:
a time of flight sensor positioned at the top of or above a fluid container and optically coupled to a fluid, the time of flight sensor configured to calculate a distance from the sensor to the fluid by emitting a laser pulse and measuring an amount of time it takes for the laser pulse to bounce off a surface of the fluid and return to the sensor;
the time of flight sensor coupled to a data processing unit having a microprocessor or microcontroller, memory, ram, wherein the data processing unit is configured to calculate a fluid volume or a fluid position within the fluid container based on the distance relayed from the senor; and
the data processing unit coupled to a display and configured to output the fluid level or fluid volume.

2. The system of claim 1 wherein the fluid is engine oil and the fluid container is an oil tank.

3. The system of claim 2 wherein the data processing unit is further configured with a volumetric profile of the oil tank and is configured to relay a fluid level status message to the display.

4. The system of claim 3 wherein the fluid level status message indicates that the oil tank is full, that oil needs to be added, that oil level is low, or that the oil tank is empty.

5. The system of claim 1 wherein the data processing unit further comprises a means for wireless communication configured to relay the fluid level to a software application or backend cloud server.

6. The system of claim 5 wherein the means for wireless communication is configured to receive to receive and relay instructions from the backend cloud server or software application to initiate a fluid level read instruction to the data processing unit and further relay fluid level data back to the backend cloud server or software application.

7. The system of claim 6 wherein a plurality of systems are configured to communicate with a backend cloud server and relay real time fluid level data to a fleet administration database.

8. The system of claim 1 further comprising a vibration sensor coupled to the data processing unit configured to measure engine vibration levels, wherein the data processing unit is further configured to receive engine vibration level data and correlate the engine vibration data with an engine rpm measurement, further wherein the data processing unit is configured to generate a report comparing rpm measurement data to oil level data.

9. The system of claim 1 wherein the system is coupled to an internal or external power source.

10. A system for measuring engine oil comprising:
a time of flight sensor positioned at the top of or above an oil pan and optically coupled to oil with the oil pan, the time of flight sensor configured to measure a distance between oil within the pan and the sensor;
a data processing unit having a microprocessor or microcontroller, memory, and ram coupled to the time of flight sensor, the data processing unit configured to receive time of flight sensor data and calculate a volume of oil remaining in the pan;
a display coupled to the data processing unit configured to output data received from the data processing unit; and
a power supply coupled directly or indirectly to the time of flight sensor, data processing unit and display.

11. The system of claim 10 wherein the data processing unit further comprises a means for wireless communication.

12. A method measuring engine oil using the system of claim 10 comprising the steps of:
powering on the system;
activating the time of flight sensor to measure a first distance between the time of flight sensor and oil within the oil pan and relaying the distance to the data processing unit;
loading an oil pan volumetric profile and time of flight senor position data into the data processing unit;
initiating the data processing unit to run a first software routine configured to calculate oil volume by subtracting the measured first distance from the oil pan volumetric profile;
comparing the oil volume to preset oil level ranges; and
displaying the oil level range on the display.

13. The method of measuring engine oil of claim 12 wherein the step of loading an oil pan volumetric profile into the data processing unit includes the steps calibrating the data processing unit with a new volumetric profile by:
adding oil to the oil pan until the oil reaches a first oil height level;
activating the time of flight sensor to measure a first level distance between the time of flight sensor and oil at the first oil height level and relay the first level distance to the data processing unit;
designating the first oil height level as add oil level within the data processing unit;
adding oil to the oil pan until the oil reaches a second oil height level;
activating the time of flight sensor to measure a second level distance between the time of flight sensor and oil at the second oil height level and relay the second level distance to the data processing unit;
designating the second oil height level as a full oil level within the data processing unit; and
designating a third oil level beneath the first oil level as a critically low level within the data processing unit.

14. The method of measuring engine oil of claim 12 wherein the steps of loading an oil pan volumetric profile into the data processing unit further includes the steps of:
entering a fixed oil volume into the data processing unit;
adding the fixed oil volume to the oil pan;
activating the time of flight sensor to measure a first level distance between the time of flight sensor and oil at a first oil height level and relay the first level distance to the data processing unit;
repeating the adding and activating steps until the oil pan is full; and
initiating the data processing unit to run a mapping software component building the volumetric profile of the oil pan by comparing changes in height of each fixed volume increment.

15. The method of measuring engine oil of claim 13 wherein the steps of comparing the oil volume to preset oil level ranges and displaying the oil ranges includes the steps of:
comparing the measured oil height of the add level, the full level, and the critically low level with the data processing unit; and
displaying a notification on the display indicating if the measured oil height is at the full level, between the add level and the full level, beneath the add level, at or below the critically low level.

16. The method of measuring engine oil of claim 12 wherein the data processing unit further comprises a means for wireless communication and the method additionally comprises the step of wirelessly relaying the oil measurement to a backend cloud server, mobile device, or external software application.

17. A method of calculating oil consumption using the system of claim 10 comprising the steps of:
activating the time of flight sensor to measure a first oil height between the time of flight sensor and oil within the oil pan, relaying the first oil height to the data processing unit, storing the first oil height along with a first data acquisition time in an oil consumption database;
activating the time of flight sensor at a later time to measure a second oil height between the time of flight sensor and oil within the oil pan, relaying the second oil height to the data processing unit, storing the second oil height along with a second data acquisition time in an oil consumption database;
calculating change in oil height by subtracting the second oil height from the first oil height;
calculating change in time by subtracting the second data acquisition time from the first data acquisition time;
converting the change in oil height to a volumetric measurement; and
displaying the volumetric measurement and change of time on the display.

18. The method of calculating oil consumption of claim 17 wherein the data processing unit further comprises a means for wireless communication and the method additionally comprises the relaying the first oil height, first data acquisition time, second oil height, and second data acquisition time to an oil consumption database stored on a backend cloud server or mobile device.

19. The method of calculating oil consumption of claim 17 wherein a plurality of height change data points are data acquisition time points are sequentially acquired at fixed intervals and the data processing unit further generates a change in oil height over time report.
